(19) United States
(12) Patent Application Publication
(10) Pub. No.: US 2026/0192711 A1
(43) Pub. Date: Jul. 9, 2026

(54) WALK-IN DEVICE FOR VEHICLE SEAT

(71) Applicant: Hyundai Transys Inc., Seosan-si (KR)

(72) Inventor: Cheon KIM, Hwaseong-si (KR)

(21) Appl. No.: 19/421,018

(22) Filed: Dec. 16, 2025

(30) Foreign Application Priority Data
Jan. 7, 2025 (KR) 10-2025-0002264

(51) Int. Cl. B60N 2/20; B60N 2/02; B60N 2/06

(52) U.S. Cl. CPC B60N 2/20; B60N 2/02253; B60N 2/0226; B60N 2/065

(57) ABSTRACT

A walk-in device for a vehicle seat includes a moving device configured to be movable by a power operating method or a manual operating method, and a pressing device configured to simultaneously allow a seat back frame to be folded at a preset angle and allow the moving device to be moved by the manual operating method by pressing a lever of the moving device.

### CROSS-REFERENCE TO RELATED APPLICATIONS

This application claims priority to and the benefit of Korean Patent Application No. 10-2025-0002264 filed in the Korean Intellectual Property Office on January 7, 2025, the entire contents of which are incorporated herein by reference.

### TECHNICAL FIELD

The present disclosure relates to a walk-in device for a vehicle seat.

### BACKGROUND

Korean Patent Application Laid-Open No. 10-2007-0044904 discloses a long-rail walk-in composite structure for a vehicle seat including a coil spring configured to induce a seat to move in a forward/rearward direction on a lower rail, a first bracket mounted on an upper rail on which the seat is installed, a second bracket separably coupled to the first bracket and configured to support one end of the coil spring through a first fastening hole, a third bracket mounted on the lower rail and configured to support the other end of the coil spring through a second fastening hole, and a fourth bracket mounted on the lower rail, provided between the second bracket and the third bracket, and configured to restrict a forward movement of the second bracket.

In general, seats may be mounted in a vehicle. The vehicle seat may include a seatback configured to support a passenger's upper body, a seat cushion configured to support the passenger's lower body, and a headrest configured to support the passenger's head.

Seat rails, which are applied to second-row or third-row seats in sport utility vehicles (SUVs) or multi-purpose vehicles (MPVs), may long rails longer in length than seat rails mounted in general passenger vehicles.

The vehicle seats may be classified into power seats and manual seats. The power seat may be moved to a desired position by an operation of a motor performed only by an operation of a switch. The manual seat may be moved by a manual operation.

However, a long rail operating structure in the related art has a structure in which an electromagnetic clutch, a rack, and a pinion engage with one another. As a result, a large amount of time is required to produce the long rail operating structure, which inevitably increases costs. Further, the long rail operating structure is operated by rotations of a plurality of pinions, which degrades operational performance.

### Document of Related Art

### Patent Document

(Patent Document 1) Korean Patent Application Laid-Open No. 10-2007-0044904 (published on May 2, 2007)

### SUMMARY

The present disclosure has been made in an effort to solve the above-mentioned problem, and an object of the present disclosure is to provide a walk-in device for a vehicle seat that allows a second-row seat to be moved by a power operating method using a motor at ordinary times and allows the second-row seat to be moved by a manual operating method, which is faster than the power operating method, when a passenger enters or exits a third-row seat.

In order to achieve the above-mentioned object, the present disclosure provides a walk-in device for a vehicle seat, the walk-in device including: a moving device configured to move by a power operation or a manual operation; and a pressing device configured to simultaneously allow a seat back frame to be folded at a preset angle and allow the moving device to be moved by the manual manual operation by pressing a lever of the moving device, in which the moving device includes: a lead screw; a lead nut screw-coupled to the lead screw and configured to move along the lead screw; and a worm wheel coupled to an outer-diameter portion of the lead nut.

In addition, the moving device may further include: a locking member disposed between the outer-diameter portion of the lead nut and an inner-diameter portion of the worm wheel; and a clutch drum coupled to one side of the outer-diameter portion of the lead nut and positioned opposite to the worm wheel, the clutch drum being configured to perform an engagement operation to release a locked state of the locking member and prevent power of the worm wheel from being transmitted to the lead nut.

In addition, the locking member may include: a first locking member and a second locking member disposed on one side of the inner-diameter portion of the worm wheel; and a third locking member and a fourth locking member disposed on another side of the inner-diameter portion of the worm wheel opposite to the one side of the inner-diameter portion of the worm wheel, and the clutch drum may include: a first coupling protrusion and a second coupling protrusion disposed on one surface of the clutch drum directed toward the worm wheel; and at least one key disposed on an inner-diameter portion of the clutch drum and coupled to a key groove defined on in the lead nut in a longitudinal direction, the at least one key being configured to slide along the key groove.

In addition, a support member may be disposed between the worm wheel and the clutch drum, first and second support protrusions may be disposed on one surface of the support member and inserted into the inner-diameter portion of the worm wheel, and a first support surface, a second support surface, a third support surface, and a fourth support surface may be defined around one side of the lead nut.

In addition, the first locking member may include: a first elastic body having one end supported on the one side of the inner-diameter portion of the worm wheel by the first support protrusion; and a first roller configured to be pushed by an elastic force of the first elastic body and fitted between the inner-diameter portion of the worm wheel and one end of the first support surface such that the worm wheel and the lead nut are integrally rotatable, the second locking member may include: a second elastic body positioned opposite to the first elastic body on the one side of the inner-diameter portion of the worm wheel and having one end supported by the second support protrusion; and a second roller positioned opposite to the first roller, the second roller being configured to be pushed by an elastic force of the second elastic body and fitted between the inner-diameter portion of the worm wheel and one end of the second support surface such that the worm wheel and the lead nut are integrally rotatable, the third locking member may include: a third elastic body having one end supported on the another side of the inner-diameter portion of the worm wheel by the first support protrusion; and a third roller configured to be pushed by an elastic force of the third elastic body and fitted between the inner-diameter portion of the worm wheel and one end of the third support surface such that the worm wheel and the lead nut are integrally rotatable, and the fourth locking member may include: a fourth elastic body positioned opposite to the third elastic body on the another side of the inner-diameter portion of the worm wheel and having one end supported by the second support protrusion; and a fourth roller positioned opposite to the third roller, the fourth roller being configured to be pushed by an elastic force of the fourth elastic body and fitted between the inner-diameter portion of the worm wheel and one end of the fourth support surface such that the worm wheel and the lead nut are integrally rotatable.

In addition, a width between the inner-diameter portion of the worm wheel and each of the first and second support surfaces may increase from the one end of each of the first and second support surfaces toward another end of each of the first and second support surfaces, and a width between the inner-diameter portion of the worm wheel and each of the third and fourth support surfaces may increase from the one end of each of the third and fourth support surfaces toward another end of each of the third and fourth support surfaces.

In addition, each of the first and second rollers may be configured to be released as each of the first and second rollers is pushed toward the another end of each of the first and second support surfaces by the first coupling protrusion inserted between the first and second rollers.

In addition, each of the third and fourth rollers may be configured to be released as each of the third and fourth rollers is pushed toward the another end of each of the third and fourth support surfaces by the second coupling protrusion inserted between the third and fourth rollers.

In addition, the support member and the clutch drum may be elastically supported by a first elastic member disposed between the support member and the clutch drum.

In addition, a shift ring may be coupled to an outer-diameter portion of the clutch drum, and the clutch drum may be rotatable together with the lead nut in a state in which the clutch drum is supported on the shift ring.

In addition, the shift ring may include: a main body having a ring shape and including an inner ring portion and an outer ring portion, the inner ring portion being inserted and coupled into a coupling groove disposed on an outer-diameter portion of the clutch drum; and a cut-out portion defined between one end and another end of the main body.

In addition, a coupling pin may be coupled to penetrate the one end of the main body, one end of a lever, and the another end of the main body in a state in which the one end of the lever is inserted into the cut-out portion of the main body.

In addition, the first elastic member may be configured to be compressed when the clutch drum is moved in an engagement direction by a force applied to the lever, and the clutch drum may be configured to be moved in a disengagement direction by a restoring force of the first elastic member when the force applied to the lever is eliminated.

In addition, the worm wheel may be connected to a power source by a power transmission member.

In addition, the power transmission member may be a belt, and a gear portion disposed on an inner-diameter portion of the power transmission member may be configured to engage with a gear portion disposed on an outer-diameter portion of the worm wheel.

In addition, each of the first support surface, the second support surface, the third support surface, and the fourth support surface may truncate the outer-diameter portion of the lead nut and extend in a longitudinal direction of the lead nut, each of the first support surface, the second support surface, the third support surface, and the fourth support surface may terminate at a point along the longitudinal direction to define a stepped projection on the outer-diameter portion of the lead nut, the first locking member may be attached to and supported on the stepped projection of the first support surface, the second locking member may be attached to and supported on the stepped projection of the second support surface, the third locking member may be attached to and supported on the stepped projection of the third support surface, and the fourth locking member may be attached to and supported on the stepped projection of the fourth support surface.

In addition, the pressing device may include: a first operating lever disposed at one side of a seat cushion frame; a second operating lever disposed on an upper portion of the seat back frame; and a first cable having one end connected to the first operating lever and another end connected to a first bracket disposed adjacent to an outer side of a joint part to which the seat cushion frame and the seat back frame are connected.

In addition, the pressing device may further include: a second cable having one end connected to the second operating lever and another end connected to the first bracket; a third cable having one end connected to a second bracket disposed at an inner side of the seat cushion frame; and a rotary lever rotatably coupled to an upper rail of a seat rail by a hinge pin and having one end connected to another end of the third cable, the rotary lever having another end connected to the lever by a hinge shaft, the lever being disposed on a shift ring of the moving device.

In addition, a third bracket may be disposed between the seat cushion frame and the second bracket, a first hinge shaft may be coupled to the seat cushion frame, the first hinge shaft penetrating a center of the first bracket, a center of the second bracket, and a center of the third bracket, and the first bracket may be configured to transmit a rotational force of the first bracket to the second bracket and the third bracket through the first hinge shaft.

In addition, a second hinge shaft may be coupled to penetrate a center of the joint part and penetrate centers of a gear bracket and a support bracket disposed at an inner side of the joint part, a second elastic member may be coupled to an outer-diameter portion of the support bracket, and one end of the second elastic member may be caught by the seat cushion frame and another end of the second elastic member may be caught by a catching portion of the support bracket.

In addition, the gear bracket may include a first gear portion, a locking bracket may be disposed between the gear bracket and the third bracket, one end of the locking bracket may be rotatably coupled to the seat cushion frame by a third hinge shaft, and the locking bracket may include a groove, a second gear portion, and a restraining protrusion.

In addition, the locking bracket may be configured to implement an upright state of the seat back frame as the second gear portion of the locking bracket engages with the first gear portion of the gear bracket in a restrained state in which a locking protrusion of the third bracket supports the restraining protrusion.

In addition, when the rotational force of the first bracket is applied to the first hinge shaft, the third bracket may be configured to rotate together with the first hinge shaft, the locking protrusion, which supports the restraining protrusion, may be configured to be inserted into the groove of the locking bracket, the locking bracket may be configured to rotate about the third hinge shaft, the first gear portion and the second gear portion may be configured to be disengaged to release a restrained state of the gear bracket, and the seat back frame may be configured to be folded at a preset angle by an elastic restoring force of the second elastic member.

In addition, the second elastic member may be configured to be compressed in a state in which the first gear portion and the second gear portion engage with each other, and the second elastic member may be configured to push the seat back frame by the elastic restoring force to allow the seat back frame to be folded at the preset angle in a state in which the first gear portion and the second gear portion are disengaged.

According to the present disclosure, it is possible to minimize the number of components in comparison with the walk-in device for a vehicle seat in the related art.

In addition, according to the present disclosure, it is possible to reduce costs in comparison with the walk-in device for a vehicle seat in the related art.

In addition, according to the present disclosure, it is possible to significantly improve the operational sensitivity and stability by means of the meshing structure of the lead screw.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view illustrating a state in which a moving device according to an exemplary embodiment of the present disclosure is mounted on a seat rail.

FIG. 2 is a cross-sectional view taken along line A-A in FIG. 1.

FIG. 3 is an exploded perspective view of the moving device according to the exemplary embodiment of the present disclosure.

FIG. 4 is a cross-sectional view taken along line B-B in FIG. 2.

FIG. 5 is a view illustrating a state in which a first operating lever and a first cable are connected and a second bracket and a third cable are connected in a pressing device according to the exemplary embodiment of the present disclosure.

FIG. 6 is a view illustrating a state in which a second lever and a second cable are connected and the first and second cables and a first bracket are connected in the pressing device according to the exemplary embodiment of the present disclosure.

FIG. 7 is a view illustrating the third cable, which is pulled by the second bracket of the pressing device, a gear bracket, a support bracket, and a second elastic member mounted on a joint part according to the exemplary embodiment of the present disclosure.

FIG. 8 is a view illustrating a third bracket, a locking bracket, a rotary bracket, and the gear bracket of the pressing device according to the exemplary embodiment of the present disclosure.

FIG. 9 is a view illustrating operations of the second bracket and the third cable of the pressing device according to the exemplary embodiment of the present disclosure.

FIG. 10 is a view illustrating lever operations of a rotary lever and the moving device implemented by the operation of the third cable of the pressing device according to the exemplary embodiment of the present disclosure.

FIG. 11 is a view illustrating a state in which a clutch drum is coupled to a lead nut by an operation of the pressing device according to the exemplary embodiment of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, exemplary embodiments of the present disclosure will be described in detail with reference to the accompanying drawings. First, in assigning reference numerals to constituent elements of the respective drawings, it should be noted that the same constituent elements will be designated by the same reference numerals, if possible, even though the constituent elements are illustrated in different drawings. In addition, in the description of the present disclosure, the specific descriptions of publicly known related configurations or functions will be omitted when it is determined that the specific descriptions may obscure the subject matter of the present disclosure. Further, the exemplary embodiments of the present disclosure will be described below, but the technical spirit of the present disclosure is not limited thereto and may, of course, be modified and variously carried out by those skilled in the art.

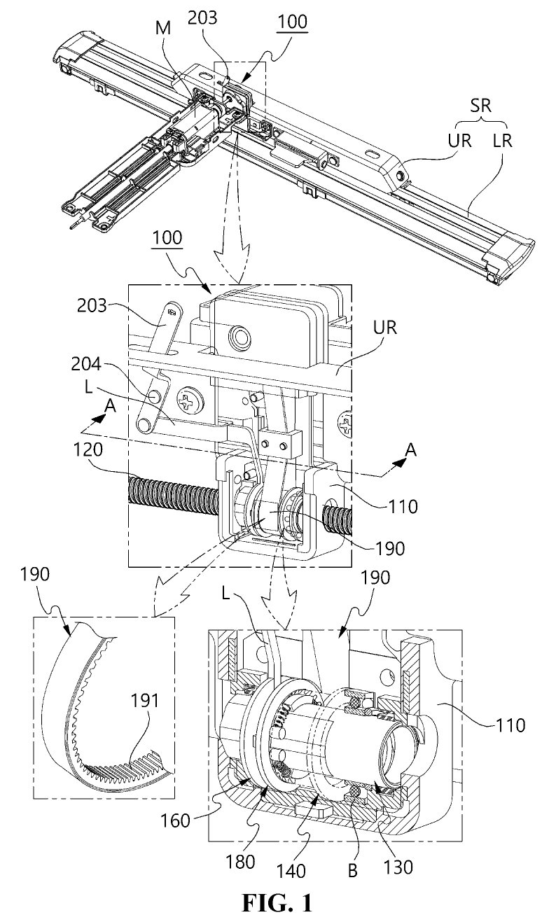

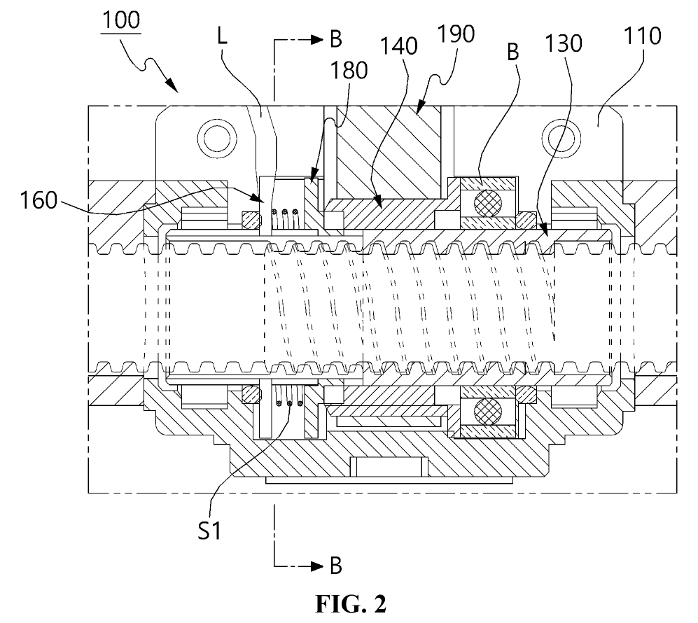

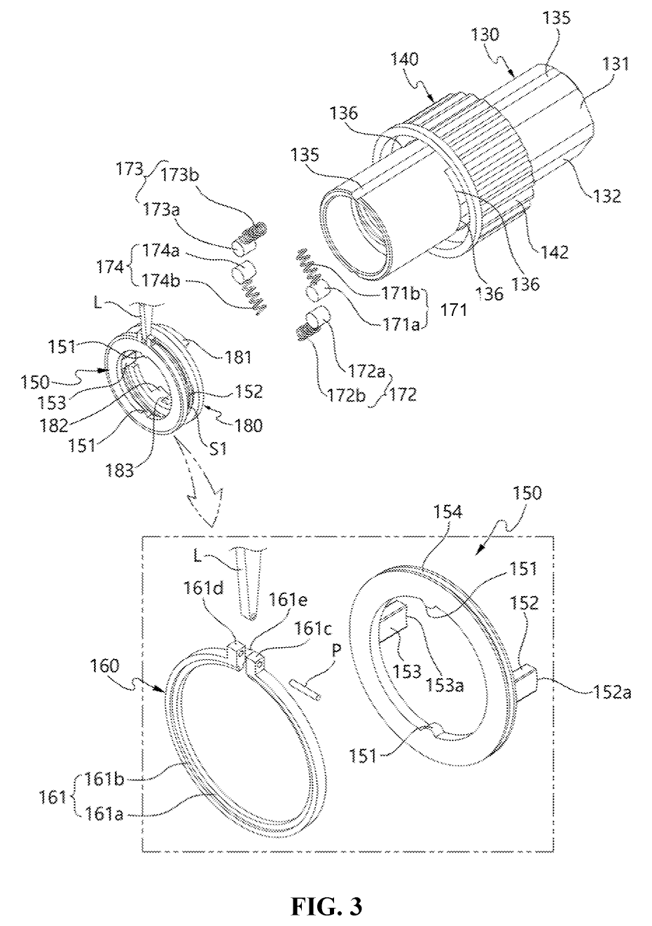

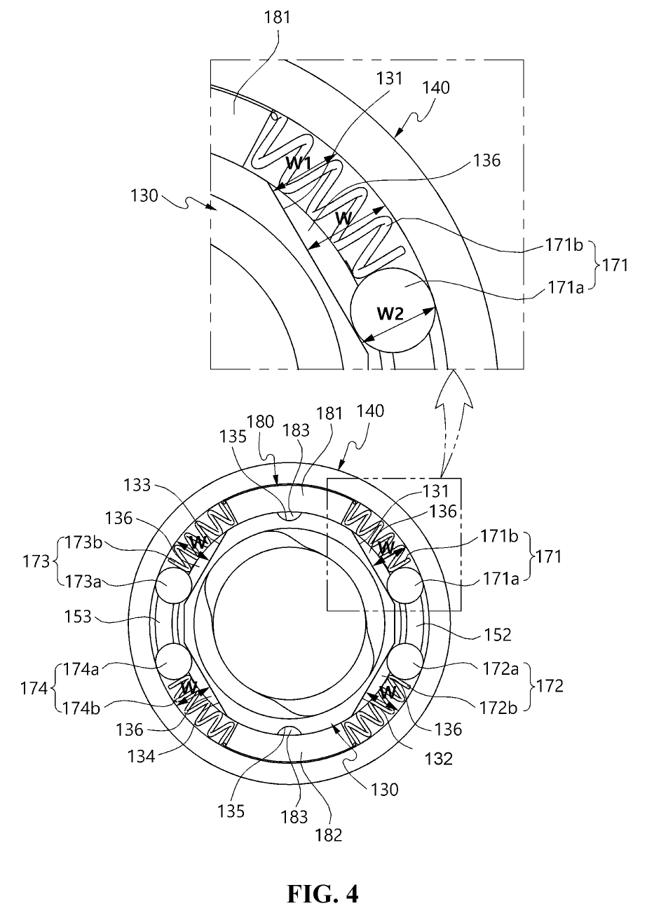

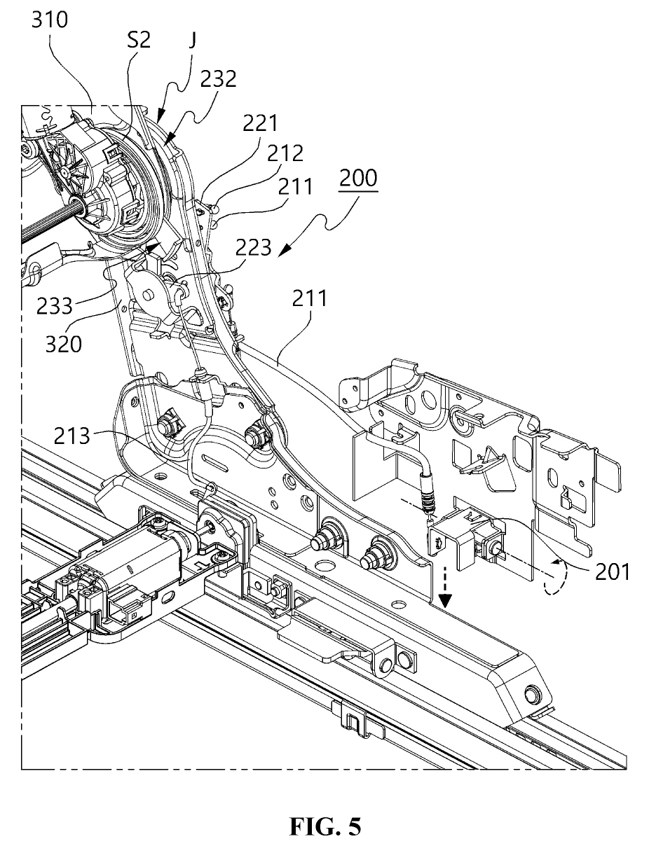

FIG. 1 is a view illustrating a state in which a moving device according to an exemplary embodiment of the present disclosure is mounted on a seat rail. FIG. 2 is a cross-sectional view taken along line A-A in FIG. 1. FIG. 3 is an exploded perspective view of the moving device according to the exemplary embodiment of the present disclosure. FIG. 4 is a cross-sectional view taken along line B-B in FIG. 2. FIG. 5 is a view illustrating a state in which a first operating lever and a first cable are connected and a second bracket and a third cable are connected in a pressing device according to the exemplary embodiment of the present disclosure.

As illustrated in FIGS. 1 to 5, a walk-in device for a vehicle seat of the present disclosure may include a moving device 100 configured to be moved by a power operating method using a motor or a manual operating method, and a pressing device 200 configured to simultaneously allow a seat back frame 310 to be foldable at a preset angle and allow the moving device 100 to be movable by the manual operating method by pressing a lever L of the moving device 100.

The moving device 100 may include a casing 110, a lead nut 130, a worm wheel 140, locking members, a clutch drum 150, a support member 180, and a first elastic member S1.

The support member 180 and the clutch drum 150 may be elastically supported by the first elastic member S1. The first elastic member S1 may be positioned between the support member 180 and the clutch drum 150. For example, the first elastic member S1 may be a coil spring.

A lead screw 120 may be coupled to penetrate the casing 110. The casing 110 may move along the lead screw 120.

A seat rail SR may include a lower rail LR and an upper rail UR. The moving device 100 may be mounted on the upper rail UR.

The lead screw 120 may be inserted and coupled into the lower rail LR. The lower rail LR may be coupled to a floor panel (not illustrated) in the vehicle. The casing 110 may be connected to the upper rail UR. The upper rail UR may be connected to a vehicle seat (not illustrated). When the casing 110 moves, the vehicle seat (not illustrated) connected to the upper rail UR may be moved.

The lead nut 130 may be screw-coupled to the lead screw 120. The lead nut 130 may move along the lead screw 120.

The lead screw 120 may include a high thread such as a high helix or a trapezoidal thread.

In order to facilitate a manual operation, an angle of a screw thread of a tooth of the lead screw 120 may be designed to be larger than that in the related art. It is necessary to design the lead nut 130 with the high thread so that the lead nut 130 may be operated even with a low force in comparison with the related art. An outer-diameter portion of the lead nut 130, which is screw-coupled to the lead screw 120, may be supported by a bearing B.

An outer race of the bearing B may be assembled to the casing 110 by press-fitting. An inner race of the bearing B may rotate in a state in which the inner race of the bearing B is coupled to the lead nut 130. Therefore, in a case in which an external force is applied to the seat (not illustrated), the lead nut 130 may rotate together with the inner race of the bearing B. Therefore, the lead nut 130 may easily move along the lead screw 120 including the high thread.

In a walk-in mode, the movement of the lead nut 130 may be performed by an operation of the pressing device 200. When the pressing device 200 operates, an unlocked state of the moving device 100 may be implemented so that the seat back frame 310 may be foldable at a preset angle and the moving device 100 may be movable by the manual operating method.

The lead nut 130 may include key grooves 135, a first support surface 131, a second support surface 132, a third support surface 133, and a fourth support surface 134. The key grooves 135 may be provided in a longitudinal direction of the lead nut 130. At least one key groove 135 may be provided. The key grooves 135 may be disposed at two opposite sides and provided to be opposite to each other.

The worm wheel 140 may have a gear portion 142. The gear portion 142 may be provided on an outer-diameter portion of the worm wheel 140. The worm wheel 140 may be connected to a power source M by a power transmission member 190 such as a belt.

For example, the power source M may be a motor. The power source M may be connected to the power transmission member 190 by a gear or the like.

A gear portion 191 may be provided on an inner-diameter portion of the power transmission member 190. The gear portion 191 of the power transmission member 190 may engage with the gear portion 142 of the worm wheel 140.

Power of the power source M may be transmitted to the worm wheel 140 via the power transmission member 190.

A first support protrusion 181 and a second support protrusion 182 may be provided on one surface of the support member 180. The first support protrusion 181 and the second support protrusion 182 may be inserted into the inner-diameter portion of the worm wheel 140. Keys 183 may be provided on an inner-diameter portion of the first support protrusion 181 and an inner-diameter portion of the second support protrusion 182. The keys 183 may be inserted into the key grooves 135 of the lead nut 130.

The locking members may include a first locking member 171, a second locking member 172, a third locking member 173, and a fourth locking member 174. The first locking member 171 and the second locking member 172 may be positioned on one side inner-diameter portion of the worm wheel 140. The third locking member 173 and the fourth locking member 174 may be positioned on the other side inner-diameter portion of the worm wheel 140.

The first locking member 171 may include a first elastic body 171b and a first roller 171a. The first elastic body 171b may be a spring.

One end of the first elastic body 171b may be supported on one side inner-diameter portion of the worm wheel 140 by the first support protrusion 181.

The first roller 171a may be elastically supported at the other end of the first elastic body 171b by the first elastic body 171b. The first roller 171a may be pushed by an elastic force of the first elastic body 171b and fitted between the inner-diameter portion of the worm wheel 140 and one end of the first support surface 131. The worm wheel 140 and the lead nut 130 may integrally rotate in the fitted state of the first roller 171a.

The second locking member 172 may include a second elastic body 172b and a second roller 172a. The second elastic body 172b may be a spring.

The second elastic body 172b may be provided on one side inner-diameter portion of the worm wheel 140 while being opposite to the first elastic body 171b. One end of the second elastic body 172b may be supported on one side inner-diameter portion of the worm wheel 140 by the second support protrusion 182.

The second roller 172a may be provided on one side inner-diameter portion of the worm wheel 140 while being opposite to the first roller 171a. The second roller 172a may be elastically supported at the other end of the second elastic body 172b by the second elastic body 172b. The second roller 172a may be pushed by an elastic force of the second elastic body 172b and fitted between the inner-diameter portion of the worm wheel 140 and one end of the second support surface 132. The worm wheel 140 and the lead nut 130 may integrally rotate in the fitted state of the second roller 172a.

The third locking member 173 may include a third elastic body 173b and a third roller 173a. The third elastic body 173b may be a spring.

One end of the third elastic body 173b may be supported on the other side inner-diameter portion of the worm wheel 140 by the first support protrusion 181.

The third roller 173a may be elastically supported at the other end of the third elastic body 173b by the third elastic body 173b. The third roller 173a may be pushed by an elastic force of the third elastic body 173b and fitted between the inner-diameter portion of the worm wheel 140 and one end of the third support surface 133. The worm wheel 140 and the lead nut 130 may integrally rotate in the fitted state of the third roller 173a.

The fourth locking member 174 may include a fourth elastic body 174b and a fourth roller 174a. The fourth elastic body 174b may be a spring.

The fourth elastic body 174b may be provided on the other side inner-diameter portion of the worm wheel 140 while being opposite to the third elastic body 173b. One end of the fourth elastic body 174b may be supported on the other side inner-diameter portion of the worm wheel 140 by the second support protrusion 182.

The fourth roller 174a may be provided on the other side inner-diameter portion of the worm wheel 140 while being opposite to the third roller 173a. The fourth roller 174a may be elastically supported at the other end of the fourth elastic body 174b by the fourth elastic body 174b. The fourth roller 174a may be pushed by an elastic force of the fourth elastic body 174b and fitted between the inner-diameter portion of the worm wheel 140 and one end of the fourth support surface 134. The worm wheel 140 and the lead nut 130 may integrally rotate in the fitted state of the fourth roller 174a.

Stepped projections 136, which respectively correspond to the first to fourth support surfaces 131, 132, 133, and 134, may be formed on the outer-diameter portion of the lead nut 130 by processing the first to fourth support surfaces 131, 132, 133, and 134. The first locking member 171 may be tightly attached to and supported on the stepped projection 136 of the first support surface 131. The second locking member 172 may be tightly attached to and supported on the stepped projection 136 of the second support surface 132. The third locking member 173 may be tightly attached to and supported on the stepped projection 136 of the third support surface 133. The fourth locking member 174 may be tightly attached to and supported on the stepped projection 136 of the fourth support surface 134.

A width W between the inner-diameter portion of the worm wheel 140 and each of the first and second support surfaces 131 and 132 may increase from one end of each of the first and second support surfaces 131 and 132 toward the other end of each of the first and second support surfaces 131 and 132. A width W between the inner-diameter portion of the worm wheel 140 and each of the third and fourth support surfaces 133 and 134 may increase from one end of each of the third and fourth support surfaces 133 and 134 toward the other end of each of the third and fourth support surfaces 133 and 134.

For example, a width W2 between the inner-diameter portion of the worm wheel 140 and one end of each of the first and second support surfaces 131 and 132 may be configured as a width that conforms to each of the first and second rollers 171a and 172a so that each of the first and second rollers 171a and 172a may be fitted. A width W2 between the inner-diameter portion of the worm wheel 140 and one end of each of the third and fourth support surfaces 133 and 134 may be configured as a width that conforms to each of the third and fourth rollers 173a and 174a so that each of the third and fourth rollers 173a and 174a may be fitted.

For example, a width W1 between the inner-diameter portion of the worm wheel 140 and the other end of each of the first and second support surfaces 131 and 132 may be configured as a width larger than an outer diameter of each of the first and second rollers 171a and 172a so that each of the first and second rollers 171a and 172a may be released. The width W1 between the inner-diameter portion of the worm wheel 140 and the other end of each of the third and fourth support surfaces 133 and 134 may be configured as a width larger than an outer diameter of each of the third and fourth rollers 173a and 174a so that each of the third and fourth rollers 173a and 174a may be released.

The locked states of the first locking member 171, the second locking member 172, the third locking member 173, and the fourth locking member 174 may be released by an engagement operation of the clutch drum 150. Therefore, it is possible to prevent power of the power source M from being transmitted to the lead nut 130 via the worm wheel 140.

The clutch drum 150 may include a first coupling protrusion 152, a second coupling protrusion 153, and keys 151. The first coupling protrusion 152 and the second coupling protrusion 153 may be configured as a pair of coupling protrusions provided on one surface of the clutch drum 150. The first coupling protrusion 152 and the second coupling protrusion 153 may protrude toward the worm wheel 140.

The first coupling protrusion 152 and the second coupling protrusion 153 may be formed in a direction intersecting the first support protrusion 181 and the second support protrusion 182 to prevent interference with the first support protrusion 181 and the second support protrusion 182.

For example, in a case that the first support protrusion 181 and the second support protrusion 182 are formed in a vertical direction, the first coupling protrusion 152 and the second coupling protrusion 153 may be formed in a horizontal direction.

For example, the first coupling protrusion 152 and the second coupling protrusion 153 may each have a width that decreases toward each of ends 152a and 153a. A width of the end 152a of the first coupling protrusion 152 may conform to a width between the first and second rollers 171a and 172a. A width of the end 153a of the second coupling protrusion 153 may conform to a width between the third and fourth rollers 173a and 174a. As the first coupling protrusion 152 is inserted more deeply between the first and second rollers 171a and 172a, the width between the first and second rollers 171a and 172a may further increase. As the second coupling protrusion 153 is inserted more deeply between the third and fourth rollers 173a and 174a, the width between the third and fourth rollers 173a and 174a may further increase.

The first roller 171a and the second roller 172a may be pushed in an unlocking direction by the first coupling protrusion 152 inserted between the first roller 171a and the second roller 172a.

The third roller 173a and the fourth roller 174a may be pushed in the unlocking direction by the second coupling protrusion 153 inserted between the third roller 173a and the fourth roller 174a.

At least one key 151 may be provided on an inner-diameter portion of the clutch drum 150. The key 151 of the clutch drum 150 may be inserted into the key groove 135 of the lead nut 130 and stably slide along the key groove 135.

A shift ring 160 may be coupled to an outer-diameter portion of the clutch drum 150. The clutch drum 150 may rotate together with the lead nut 130 in a state in which the clutch drum 150 is supported on the shift ring 160.

The shift ring 160 may be configured in a ring shape. The shift ring 160 may include a main body 161 and a cut-out portion 161e. The main body 161 may include an inner ring portion 161a and an outer ring portion 161b. The inner ring portion 161a may be inserted and coupled into a coupling groove 154 provided in the outer-diameter portion of the clutch drum 150.

The cut-out portion 161e may be formed between one end 161c and the other end 161d of the main body 161. One end of the lever L may be inserted into the cut-out portion 161e.

The lever L and the shift ring 160 may be assembled by a coupling pin P. The lever L may be configured in various shapes. For example, any shape may be provided as long as the shape may transmit a force of the pressing device 200.

The coupling pin P may be coupled to penetrate one end 161c of the main body 161, one end of the lever L, and the other end 161d of the main body 161 in a state in which one end of the lever L is inserted into the cut-out portion 161e.

Next, an operation of the moving device of the present disclosure will be described.

As illustrated in FIGS. 1 to 4, the clutch drum 150 may move in an engagement direction when a force of the pressing device 200 is applied to the lever L.

In this case, the first elastic member S1 positioned between the support member 180 and the clutch drum 150 may be compressed by the clutch drum 150.

When the clutch drum 150 moves in the engagement direction, the first coupling protrusion 152 of the clutch drum 150 may be inserted between the first and second rollers 171a and 172a, and the second coupling protrusion 153 may be inserted between the third and fourth rollers 173a and 174a.

The first roller 171a is pushed by the first coupling protrusion 152 of the clutch drum 150 and moved in the direction from one end to the other end of the first support surface 131, such that an unlocked state in which the first roller 171a is released may be implemented.

The second roller 172a is pushed by the first coupling protrusion 152 of the clutch drum 150 and moved in the direction from one end to the other end of the second support surface 132, such that an unlocked state in which the second roller 172a is released may be implemented.

The third roller 173a is pushed by the second coupling protrusion 153 of the clutch drum 150 and moved in the direction from one end to the other end of the third support surface 133, such that an unlocked state in which the third roller 173a is released may be implemented.

The fourth roller 174a is pushed by the second coupling protrusion 153 of the clutch drum 150 and moved in the direction from one end to the other end of the fourth support surface 134, such that an unlocked state in which the fourth roller 174a is released may be implemented.

Because the worm wheel 140 and the lead nut 130 cannot integrally rotate in the unlocked states of the first to fourth rollers 171a, 172a, 173a, and 174a, the power of the power source M, such as the motor, cannot be transmitted to the lead nut 130 via the worm wheel 140.

On the contrary, when the force of the pressing device 200 applied to the lever L is eliminated, the compressed first elastic member S1 may be restored to an original state and push the clutch drum 150 in a disengagement direction.

As the clutch drum 150 is pushed in the disengagement direction, the first coupling protrusion 152 may separate from the portion between the first and second rollers 171a and 172a, and the second coupling protrusion 153 may separate from the portion between the third and fourth rollers 173a and 174a.

As the first coupling protrusion 152 separates from the portion between the first and second rollers 171a and 172a, the first roller 171a is pushed in the direction toward one end of the first support surface 131 by the elastic force of the first elastic body 171b, and the second roller 172a is pushed in the direction toward one end of the second support surface 132 by the elastic force of the second elastic body 172b, such that the locked state in which the first roller 171a and the second roller 172a are fitted may be implemented.

As the second coupling protrusion 153 separates from the portion between the third and fourth rollers 173a and 174a, the third roller 173a is pushed in the direction toward one end of the third support surface 133 by the elastic force of the third elastic body 173b, and the fourth roller 174a is pushed in the direction toward one end of the fourth support surface 134 by the elastic force of the fourth elastic body 174b, such that the locked state in which the third roller 173a and the fourth roller 174a are fitted may be implemented.

The worm wheel 140 and the lead nut 130 may integrally rotate in the locked states of the first to fourth rollers 171a, 172a, 173a, and 174a.

When the power of the power source M, such as the motor, is transmitted to the power transmission member 190 in the locked states of the first to fourth rollers 171a, 172a, 173a, and 174a, the power of the power source M, such as the motor, is transmitted to the lead nut 130 via the power transmission member 190 and the worm wheel 140 because the gear portion 191 of the power transmission member 190 and the gear portion 142 of the worm wheel 140 engage with each other, such that the lead nut 130 may rotate.

The lead nut 130 may rotate and move along the lead screw 120 together with the casing 110.

Next, the pressing device of the present disclosure will be described.

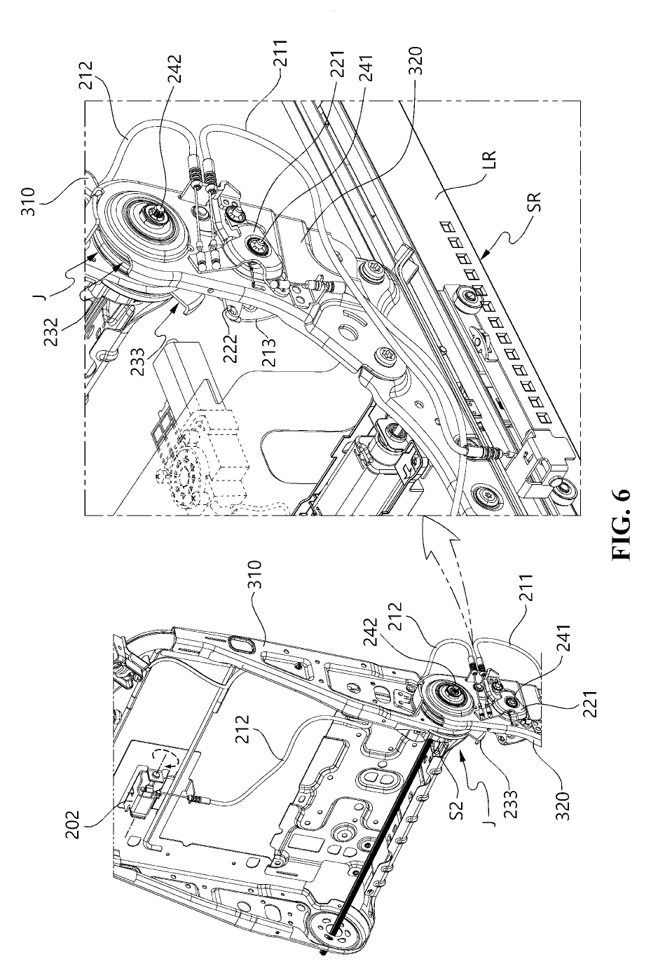

FIG. 6 is a view illustrating a state in which a second lever and a second cable are connected and the first and second cables and a first bracket are connected in the pressing device according to the exemplary embodiment of the present disclosure.

As illustrated in FIGS. 5 and 6, the pressing device 200 may include a first operating lever 201, a second operating lever 202, a first cable 211, a second cable 212, a third cable 213, and a rotary lever 203.

The first operating lever 201 may be connected to the first cable 211. As illustrated in FIG. 5, when the first operating lever 201 is rotated, the first cable 211 may be pulled in the direction toward the first operating lever 201 in conjunction with the rotation of the first operating lever 201.

The second operating lever 202 may be provided on an upper portion of the seat back frame 310. The second operating lever 202 may be connected to the second cable 212. As illustrated in FIG. 6, when the second operating lever 202 is rotated, the second cable 212 may be pulled in the direction toward the second operating lever 202 in conjunction with the rotation of the second operating lever 202.

As illustrated in FIG. 6, one end of the first cable 211 may be connected to the first operating lever 201. The other end of the first cable 211 may be connected to a first bracket 221.

The first bracket 221 may be provided on a seat cushion frame 320. The first bracket 221 may be provided in the vicinity of an outer side of a joint part J to which the seat cushion frame 320 and the seat back frame 310 are connected.

One end of the second cable 212 may be connected to the second operating lever 202. The other end of the second cable 212 may be connected to the first bracket 221.

A first hinge shaft 241 may penetrate a center of the first bracket 221 and be coupled to the seat cushion frame 320.

When the first cable 211 and the second cable 212 are pulled by the rotation of the first operating lever 201 and the rotation of the second operating lever 202, the first bracket 221 may rotate about the first hinge shaft 241, as illustrated in FIG. 6.

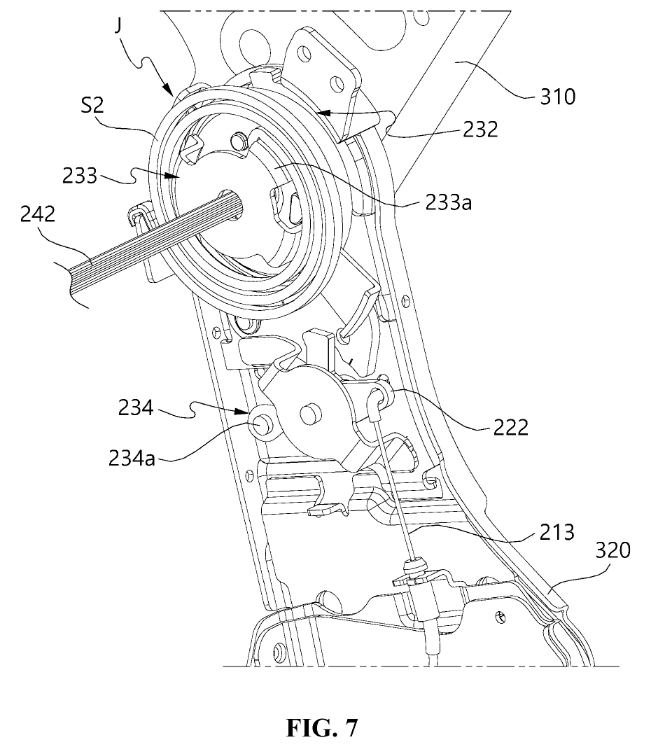

FIG. 7 is a view illustrating the third cable, which is pulled by a second bracket of the pressing device, a gear bracket, a support bracket, and a second elastic member mounted on the joint part according to the exemplary embodiment of the present disclosure.

As illustrated in FIGS. 5 and 7, one end of the third cable 213 may be connected to a second bracket 222. The other end of the third cable 213 may be connected to the lever L, which is provided on the shift ring 160 of the moving device 100, by the rotary lever 203. The other end of the rotary lever 203 may be connected to the lever L by a connection member such as a hinge shaft.

The second bracket 222 may be provided inside the seat cushion frame 320. The first hinge shaft 241 may be coupled to penetrate a center of the seat cushion frame 320 and a center of the second bracket 222.

The first bracket 221, the second bracket 222, and a third bracket 223 are connected by the first hinge shaft 241. Therefore, when a rotational force of the first bracket 221 is applied to the first hinge shaft 241, the second bracket 222 and the third bracket 223 may rotate in conjunction with the first bracket 221.

The third cable 213 may be pulled in the direction toward the second bracket 222 by the rotation of the second bracket 222 that operates in conjunction with the first bracket 221.

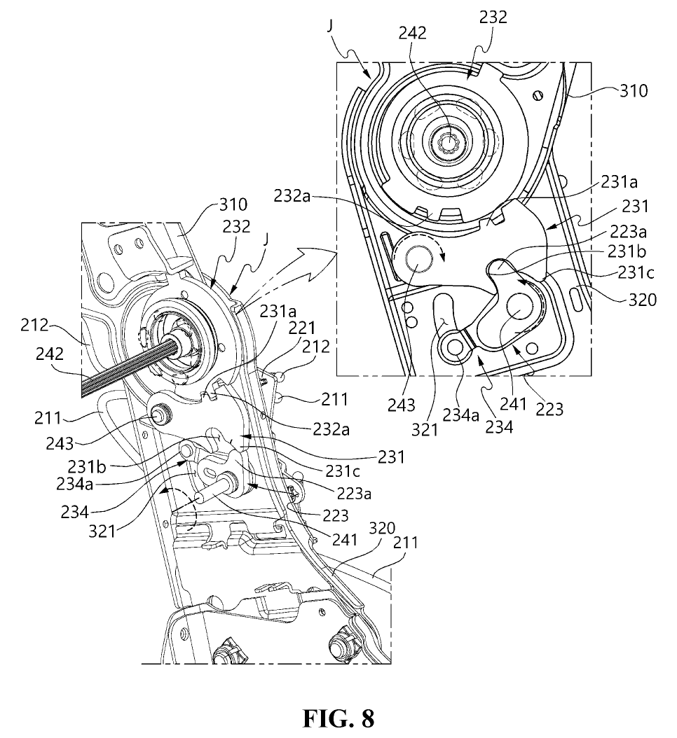

FIG. 8 is a view illustrating a third bracket, a locking bracket, a rotary bracket, and the gear bracket of the pressing device according to the exemplary embodiment of the present disclosure.

As illustrated in FIG. 8, the third bracket 223 may be provided between the seat cushion frame 320 and the second bracket 222.

The first hinge shaft 241 may be coupled to penetrate the first bracket 221, the seat cushion frame 320, the third bracket 223, and the second bracket 222. The first hinge shaft 241 may be coupled to penetrate a center of the first bracket 221, a center of the third bracket 223, and a center of the second bracket 222.

The third bracket 223 may be coupled to the first hinge shaft 241 so that the third bracket 223 is positioned between the seat cushion frame 320 and the second bracket 222.

A locking bracket 231 may be provided between the third bracket 223 and a gear bracket 232. A second hinge shaft 242 may be coupled to penetrate a center of the joint part J, a center of the gear bracket 232, and a center of a support bracket 233.

The gear bracket 232 may be positioned between the seat cushion frame 320 and the support bracket 233. The gear bracket 232 may be provided with a first gear portion 232a. The support bracket 233 may include a catching portion 233a. A second elastic member S2 may be coupled to surround an outer-diameter portion of the support bracket 233.

For example, the second elastic member S2 may be a spiral spring.

One end of the second elastic member S2 may be coupled to be caught by the seat cushion frame 320. The other end of the second elastic member S2 may be coupled to be caught by the catching portion 233a of the support bracket 233.

The locking bracket 231 may include a second gear portion 231a, a groove 231b, and a restraining protrusion 231c. One end of the locking bracket 231 may be coupled to the seat cushion frame 320 by a third hinge shaft 243. The third bracket 223 may be provided with a locking protrusion 223a.

The second gear portion 231a may be configured to be directed toward the first gear portion 232a. The groove 231b and the restraining protrusion 231c may be configured to be directed toward the locking protrusion 223a.

The first gear portion 232a of the gear bracket 232 and the second gear portion 231a of the locking bracket 231 may engage with each other in a state in which the locking protrusion 223a of the third bracket 223 presses the restraining protrusion 231c of the locking bracket 231.

In the state in which the first gear portion 232a and the second gear portion 231a engage with each other, the seat back frame 310 may be in an upright state, and the second elastic member S2 may be in a pressed state.

When the first bracket 221 rotates in the upright state of the seat back frame 310, the rotational force of the first bracket 221 is transmitted to the first hinge shaft 241, such that the third bracket 223 may rotate.

When the third bracket 223 rotates, the locking protrusion 223a, which supports the restraining protrusion 231c, may be inserted into the groove 231b of the locking bracket 231.

When the locking protrusion 223a is inserted into the groove 231b, the locking bracket 231 may rotate in a disengagement direction. When the locking bracket 231 rotates in the disengagement direction, the first gear portion 232a and the second gear portion 231a may be disengaged.

When the first gear portion 232a and the second gear portion 231a are disengaged, the compressed second elastic member S2 may be elastically restored, and the seat back frame 310 may be folded at a preset angle.

Meanwhile, a rotary bracket 234 may be provided between the seat cushion frame 320 and the third bracket 223. The first hinge shaft 241 may be coupled to penetrate one end of the rotary bracket 234. A guide pin 234a may be provided at the other end of the rotary bracket 234.

When the third bracket 223 rotates in the disengagement direction, the rotary bracket 234 may rotate together with the third bracket 223, and the guide pin 234a of the rotary bracket 234 may move along a guide hole 321 provided in the seat cushion frame 320.

Specifically, the guide pin 234a of the rotary bracket 234 may move from one end to the other end of the guide hole 321 at the same time when the locking protrusion 223a of the third bracket 223 is inserted into the groove 231b.

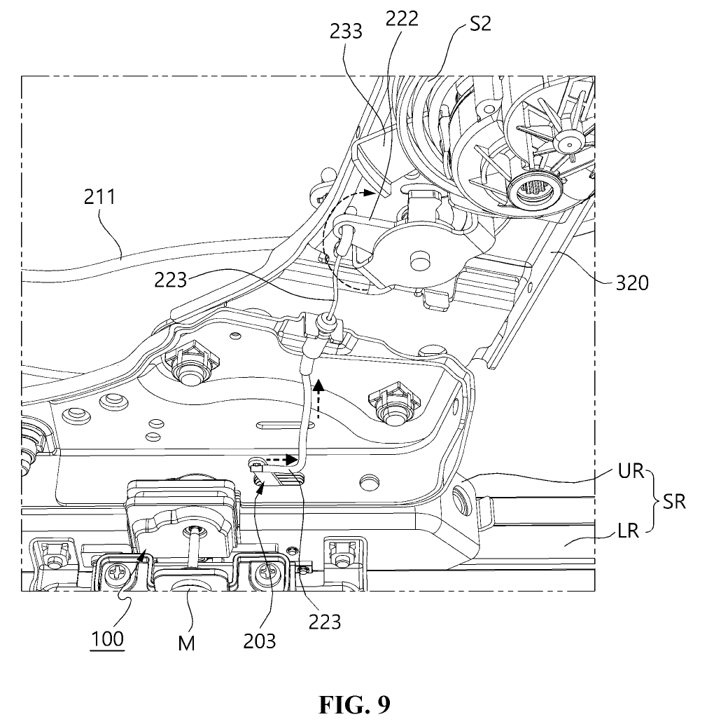

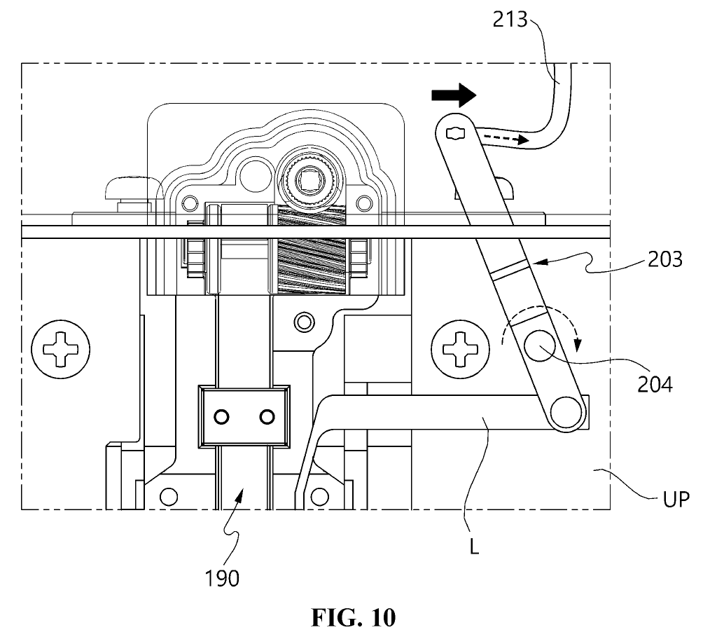

FIG. 9 is a view illustrating operations of the second bracket and the third cable of the pressing device according to the exemplary embodiment of the present disclosure. FIG. 10 is a view illustrating lever operations of the rotary lever and the moving device implemented by the operation of the third cable of the pressing device according to the exemplary embodiment of the present disclosure.

As illustrated in FIGS. 9 and 10, the rotary lever 203 may be coupled to the upper rail UR by a hinge pin 204.

One end of the rotary lever 203 may be connected to the other end of the third cable 213. The other end of the rotary lever 203 may be connected to the lever L of the shift ring 160.

In a case in which the third cable 213 is pulled by the second bracket 222, the rotary lever 203 may be pulled while being rotated about the hinge pin 204. When the rotary lever 203 is pulled, the other end of the rotary lever 203 may push the lever L of the shift ring 160.

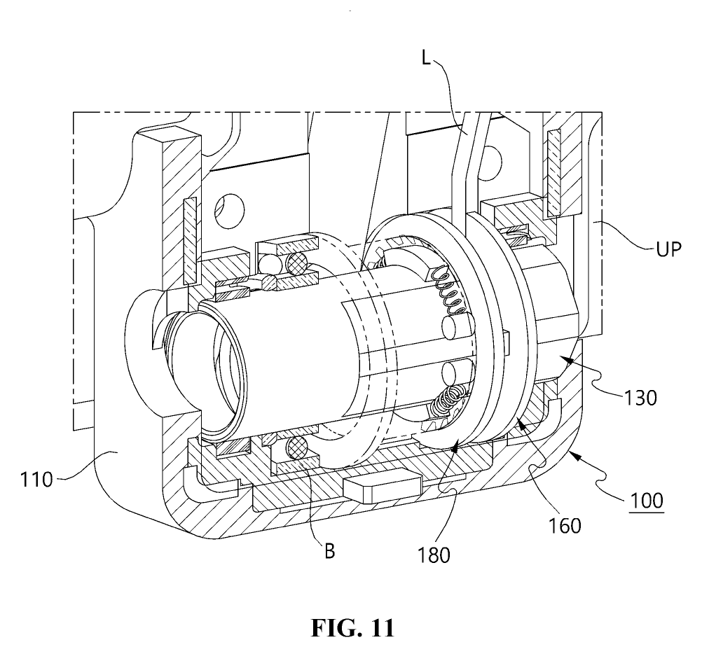

FIG. 11 is a view illustrating a state in which the clutch drum is coupled to the lead nut by an operation of the pressing device according to the exemplary embodiment of the present disclosure.

As illustrated in FIG. 11, when the lever L of the shift ring 160 is pushed by the rotary lever 203, the shift ring 160 may be pushed in the direction toward the support member 180.

Next, an operation of the pressing device of the present disclosure will be described.

As illustrated in FIGS. 5 and 6, when the first and second operating levers 201 and 202 operate, the first and second cables 211 and 212 connected to the first and second operating levers 201 and 202 may be pulled.

As illustrated in FIGS. 6 and 7, when the first and second cables 211 and 212 are pulled, the first bracket 221 connected to the first and second cables 211 and 212 may be rotated. When the first bracket 221 rotates, the rotational force of the first bracket 221 may be applied to the first hinge shaft 241, and the second bracket 222 and the third bracket 223 may simultaneously rotate in conjunction with the rotation of the first hinge shaft 241.

When the second bracket 222 rotates, the third cable 213 connected to the second bracket 222 may be pulled.

As illustrated in FIGS. 7 and 8, when the third bracket 223 rotates, the locking protrusion 223a of the third bracket 223, which supports a restraining protrusion 231c of the locking bracket 231, may be inserted into a groove 231b of the locking bracket 231.

When the locking protrusion 223a of the third bracket 223 is inserted into the groove 231b of the locking bracket 231, the locking bracket 231 may rotate about the third hinge shaft 243, and the second gear portion 231a of the locking bracket 231, which engages with the first gear portion 232a of the gear bracket 232, may be disengaged.

When the first gear portion 232a of the gear bracket 232 and the second gear portion 231a of the locking bracket 231 are disengaged, the seat back frame 310, which is positioned uprightly by being pushed by the elastic restoring force of the compressed second elastic member S2, may be folded at a preset angle.

As illustrated in FIGS. 9 and 10, when the third cable 213 is pulled, the rotary lever 203 connected to the third cable 213 may rotate about the hinge pin 204.

The lever L connected to the rotary lever 203 may be pushed as the rotary lever 203 rotates in a pressing direction.

As illustrated in FIG. 11, when the lever L is pushed, the clutch drum 150, together with the shift ring 160 connected to the lever L, is pushed in the direction toward the lead nut 130, such that the unlocked states of the first to fourth locking members 171, 172, 173, and 174 may be implemented as the first and second coupling protrusions 152 and 153 of the clutch drum 150 are coupled to the lead nut 130.

Because the worm wheel 140 and the lead nut 130 cannot integrally rotate in the unlocked states of the first to fourth locking members 171, 172, 173, and 174, a manual operation state may be implemented in which the power of the power source M, such as the motor, cannot be transmitted to the lead nut 130 via the worm wheel 140.

When a passenger pushes the seat (not illustrated) by applying a force to the seat (not illustrated) in the manual operation state, the lead nut 130 of the moving device 100 may move along the lead screw 120.

Specifically, the upper rail UR, on which the moving device 100 is mounted, may move along the lower rail LR as the lead nut 130 moves along the lead screw 120. As a result, it is possible to ensure a space through which the passenger may enter or exit the third-row seat.

On the contrary, when the force of the pressing device 200 applied to the lever L is eliminated, a power driving state may be implemented by the motor.

Specifically, when the force of the pressing device 200 applied to the lever L is eliminated, the first elastic member S1, which is compressed by being pushed by the clutch drum 150, may be restored to the original state, such that the clutch drum 150 may be moved in the locking direction by being pushed by the restoring force of the first elastic member S1.

The locked states of the first to fourth locking members 171, 172, 173, and 174 may be implemented as the clutch drum 150 moves in the locking direction.

Because the worm wheel 140 and the lead nut 130 may integrally rotate in the locked states of the first to fourth locking members 171, 172, 173, and 174, the power of the power source M, such as the motor, may be transmitted to the lead nut 130 via the power transmission member 190 and the worm wheel 140.

The moving device 100 may move along the lead screw 120 as the power of the power source M, such as the motor, is transmitted to the moving device 100, as described above.

As described above, according to the present disclosure, the walk-in device may be operated by the manual operating method or the automatic power operating method without a separate device, thereby achieving a decrease in a number of components, cost reduction due to the decrease in the number of components, and improved operational feel.

The above description is simply given for illustratively describing the technical spirit of the present disclosure, and those skilled in the art to which the present disclosure pertains will appreciate that various modifications, changes, and substitutions are possible without departing from the essential characteristics of the present disclosure. Accordingly, the embodiments disclosed in the present disclosure and the accompanying drawings are intended not to limit but to describe the technical spirit of the present disclosure, and the scope of the technical spirit of the present disclosure is not limited by the embodiments and the accompanying drawings. The protective scope of the present disclosure should be construed based on the following claims, and all the technical spirit in the equivalent scope thereto should be construed as falling within the scope of the present disclosure.

As described above, the exemplary embodiments have been described and illustrated in the drawings and the specification. The exemplary embodiments were chosen and described in order to explain certain principles of the disclosure and their practical application, to thereby enable others skilled in the art to make and utilize various exemplary embodiments of the present disclosure, as well as various alternatives and modifications thereof. As is evident from the foregoing description, certain aspects of the present disclosure are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the disclosure are deemed to be covered by the disclosure which is limited only by the claims which follow.

### Description of Reference Numerals

100: Moving device

110: Casing

120: Lead screw

130: Lead nut

140: Worm wheel

150: Clutch drum

160: Shift ring

190: Power transmission member

200: Pressing device

201: First operating lever

202: Second operating lever

203: Rotary lever

211: First cable

212: Second cable

213: Third cable

221: First bracket

222: Second bracket

223: Third bracket

242: Second hinge shaft

243: Third hinge shaft

310: Seat back frame

320: Seat cushion frame

What is claimed is:

1. A walk-in device for a vehicle seat, the walk-in device comprising:
a moving device configured to move by a power operation or a manual operation; and
a pressing device configured to simultaneously allow a seat back frame to be folded at a preset angle and allow the moving device to be moved by the manual operation by pressing a lever of the moving device,
wherein the moving device comprises:
a lead screw;
a lead nut screw-coupled to the lead screw and configured to move along the lead screw; and
a worm wheel coupled to an outer-diameter portion of the lead nut.

2. The walk-in device of claim 1, wherein the moving device further comprises:
a locking member disposed between the outer-diameter portion of the lead nut and an inner-diameter portion of the worm wheel; and
a clutch drum coupled to one side of the outer-diameter portion of the lead nut and disposed opposite to the worm wheel, the clutch drum being configured to perform an engagement operation to release a locked state of the locking member and prevent power of the worm wheel from being transmitted to the lead nut.

3. The walk-in device of claim 2, wherein the locking member comprises:
a first locking member and a second locking member disposed on one side of the inner-diameter portion of the worm wheel; and
a third locking member and a fourth locking member disposed on another side of the inner-diameter portion of the worm wheel opposite to the one side of the inner-diameter portion of the worm wheel, and
wherein the clutch drum comprises:
a first coupling protrusion and a second coupling protrusion disposed on one surface of the clutch drum directed toward the worm wheel; and
at least one key disposed on an inner-diameter portion of the clutch drum and coupled to a key groove defined on the lead nut in a longitudinal direction, the at least one key being configured to slide along the key groove.

4. The walk-in device of claim 3,
wherein a support member is disposed between the worm wheel and the clutch drum,
wherein a first support protrusion and a second support protrusion are disposed on one surface of the support member and inserted into the inner-diameter portion of the worm wheel, and
wherein a first support surface, a second support surface, a third support surface, and a fourth support surface are defined around one side of the lead nut.

5. The walk-in device of claim 4,
wherein the first locking member comprises:
a first elastic body having one end supported on the one side of inner-diameter portion of the worm wheel by the first support protrusion; and
a first roller configured to be pushed by an elastic force of the first elastic body and configured to be fitted between the inner-diameter portion of the worm wheel and one end of the first support surface such that the worm wheel and the lead nut are integrally rotatable,
wherein the second locking member comprises:
a second elastic body positioned opposite to the first elastic body on the one side of the inner-diameter portion of the worm wheel and having one end supported by the second support protrusion; and
a second roller positioned opposite to the first roller, the second roller being configured to be pushed by an elastic force of the second elastic body and configured to be fitted between the inner-diameter portion of the worm wheel and one end of the second support surface such that the worm wheel and the lead nut are integrally rotatable,
wherein the third locking member comprises:
a third elastic body having one end supported on the another side of the inner-diameter portion of the worm wheel by the first support protrusion; and
a third roller configured to be pushed by an elastic force of the third elastic body and configured to be fitted between the inner-diameter portion of the worm wheel and one end of the third support surface such that the worm wheel and the lead nut are integrally rotatable, and
wherein the fourth locking member comprises:
a fourth elastic body positioned opposite to the third elastic body on the another side of the inner-diameter portion of the worm wheel and having one end supported by the second support protrusion; and
a fourth roller positioned opposite to the third roller, the fourth roller being configured to be pushed by an elastic force of the fourth elastic body and configured to be fitted between the inner-diameter portion of the worm wheel and one end of the fourth support surface such that the worm wheel and the lead nut are integrally rotatable.

6. The walk-in device of claim 5, wherein a width between the inner-diameter portion of the worm wheel and each of the first support surface and the second support surface increases from the one end of each of the first support surface and the second support surface toward another end of each of the first support surface and second support surface, and a width between the inner-diameter portion of the worm wheel and each of the third support surface and fourth support surface increases from the one end of each of the third support surface and fourth support surface toward another end of each of the third support surface and fourth support surface.

7. The walk-in device of claim 5, wherein each of the first roller and second roller is configured to be released as each of the first roller and second roller is pushed toward the another end of each of the first support surface and second support surface by the first coupling protrusion inserted between the first roller and second roller.

8. The walk-in device of claim 5, wherein each of the third roller and fourth roller is configured to be released as each of the third roller and fourth roller is pushed toward the another end of each of the third support surface and fourth support surface by the second coupling protrusion inserted between the third roller and fourth roller.

9. The walk-in device of claim 4, wherein the support member and the clutch drum are elastically supported by a first elastic member disposed between the support member and the clutch drum.

10. The walk-in device of claim 9, wherein a shift ring is coupled to an outer-diameter portion of the clutch drum, and the clutch drum is rotatable together with the lead nut in a state in which the clutch drum is supported on the shift ring.

11. The walk-in device of claim 10, wherein the shift ring comprises:
a main body having a ring shape and including an inner ring portion and an outer ring portion, the inner ring portion being inserted and coupled into a coupling groove disposed on an outer-diameter portion of the clutch drum; and
a cut-out portion defined between one end and another end of the main body.

12. The walk-in device of claim 11, wherein a coupling pin is coupled to penetrate the one end of the main body, one end of the lever, and the another end of the main body in a state in which the one end of the lever is inserted into the cut-out portion of the main body.

13. The walk-in device of claim 12, wherein the first elastic member is configured to be compressed when the clutch drum is moved in an engagement direction by a force applied to the lever, and the clutch drum is configured to be moved in a disengagement direction by a restoring force of the first elastic member when the force applied to the lever is eliminated.

14. The walk-in device of claim 2, wherein the worm wheel is connected to a power source by a power transmission member.

15. The walk-in device of claim 14, wherein the power transmission member is a belt, and a gear portion disposed on an inner-diameter portion of the power transmission member is configured to engage with a gear portion disposed on an outer-diameter portion of the worm wheel.

16. The walk-in device of claim 5,
wherein each of the first support surface, the second support surface, the third support surface, and the fourth support surface truncates the outer-diameter portion of the lead nut and extends in a longitudinal direction of the lead nut,
wherein each of the first support surface, the second support surface, the third support surface, and the fourth support surface terminates at a point along the longitudinal direction to define a stepped projection on the outer-diameter portion of the lead nut,
wherein the first locking member is attached to and supported on the stepped projection of the first support surface, the second locking member is attached to and supported on the stepped projection of the second support surface, the third locking member is attached to and supported on the stepped projection of the third support surface, and the fourth locking member is attached to and supported on the stepped projection of the fourth support surface.

17. The walk-in device of claim 1, wherein the pressing device comprises:
a first operating lever disposed at one side of a seat cushion frame;
a second operating lever disposed on an upper portion of the seat back frame; and
a first cable having one end connected to the first operating lever and another end connected to a first bracket disposed adjacent to an outer side of a joint part to which the seat cushion frame and the seat back frame are connected.

18. The walk-in device of claim 17, wherein the pressing device further comprises:
a second cable having one end connected to the second operating lever and another end connected to the first bracket;
a third cable having one end connected to a second bracket disposed at an inner side of the seat cushion frame; and
a rotary lever rotatably coupled to an upper rail of a seat rail by a hinge pin and having one end connected to another end of the third cable, the rotary lever having another end connected to the lever by a hinge shaft, the lever being disposed on a shift ring of the moving device.

19. The walk-in device of claim 18,
wherein a third bracket is disposed between the seat cushion frame and the second bracket,
wherein a first hinge shaft is coupled to the seat cushion frame, the first hinge shaft penetrating a center of the first bracket, a center of the second bracket, and a center of the third bracket, and
wherein the first bracket is configured to transmit a rotational force of the first bracket to the second bracket and the third bracket through the first hinge shaft.

20. The walk-in device of claim 19, wherein a second hinge shaft is coupled to penetrate a center of the joint part and penetrate centers of a gear bracket and a support bracket disposed at an inner side of the joint part, a second elastic member is coupled to an outer-diameter portion of the support bracket, and one end of the second elastic member is caught by the seat cushion frame and another end of the second elastic member is caught by a catching portion of the support bracket.

21. The walk-in device of claim 20, wherein the gear bracket includes a first gear portion, a locking bracket is disposed between the gear bracket and the third bracket, one end of the locking bracket is rotatably coupled to the seat cushion frame by a third hinge shaft, and the locking bracket includes a groove, a second gear portion, and a restraining protrusion.

22. The walk-in device of claim 21, wherein the locking bracket is configured to implement an upright state of the seat back frame as the second gear portion of the locking bracket engages with the first gear portion of the gear bracket in a restrained state in which a locking protrusion of the third bracket supports the restraining protrusion.

23. The walk-in device of claim 22, wherein when the rotational force of the first bracket is applied to the first hinge shaft, the third bracket is configured to rotate together with the first hinge shaft, the locking protrusion, which supports the restraining protrusion, is configured to be inserted into the groove of the locking bracket, the locking bracket is configured to rotate about the third hinge shaft, the first gear portion and the second gear portion are configured to be disengaged to release a restrained state of the gear bracket, and the seat back frame is configured to be folded at a preset angle by an elastic restoring force of the second elastic member.

24. The walk-in device of claim 23, wherein the second elastic member is configured to be compressed in a state in which the first gear portion and the second gear portion engage with each other, and the second elastic member is configured to push the seat back frame by the elastic restoring force to allow the seat back frame to be folded at the preset angle in a state in which the first gear portion and the second gear portion are disengaged.
